(19) United States
(12) Patent Application Publication
(10) Pub. No.: US 2015/0112743 A1
(43) Pub. Date: Apr. 23, 2015

(54) SOCIAL ANALYTICS MARKETPLACE PLATFORM

(71) Applicant: SageLegion, Inc., San Francisco, CA (US)

(72) Inventor: D. Thomas Witmer, San Francisco, CA (US)

(21) Appl. No.: 14/505,376

(22) Filed: Oct. 2, 2014

Related U.S. Application Data
(60) Provisional application No. 61/886,524, filed on Oct. 3, 2013.

(51) Int. Cl. G06Q 10/06; G06Q 10/10; G06Q 50/00; G06F 17/30

(52) U.S. Cl. CPC G06Q 10/063112; G06F 17/30876; G06Q 10/103; G06Q 50/01
USPC 705/7.14

(57) ABSTRACT

An analytics platform includes a user interface providing access to the analytics platform for multiple users, a project management tool including a project definer and a task definer that makes project management resources available to a requestor user, an effectiveness rating tool providing an analytics effectiveness index for analytics provider users, and an auction management tool. The auction management tool allows the requestor user to specify an analytic task for auction, specify auction parameters and weighting of the auction parameters, and provide the specified analytic task for auctioning to ones of the users, the specified analytic task having been defined in the task definer and related to a project defined in the project definer. The auction management tool receives bids on the specified analytic task from analytics provider users; and provides received bids to the requestor user with scoring for each bid based on the parameters and the parameter weighting.

### CROSS-REFERENCE TO RELATED PATENT APPLICATIONS

This application claims the benefit of U.S. Provisional Patent Application 61/886,524 filed Oct. 3, 2013 to Witmer, titled “Social Analytics Marketplace Platform” the contents of which are incorporated herein by reference in their entirety.

### BACKGROUND

Analytics expertise in needed for a variety of tasks. However, those in need of analytics expertise may have a difficult time to find and retain available expertise and resources. Solving analytics problems can require a variety of skills including: mathematics, statistics, predictive analytic model development, machine learning algorithm programmers, and domain knowledge for specific industries. Once data mining, predictive models, and insights are discovered, communication skills are required to create effective reports, dashboards, mobile alerting, infographics and other communication artifacts. There is a need for a way to find analytics expertise and manage analytics tasks as the expertise and resources are needed.

### SUMMARY

In one aspect, an analytics platform includes a user interface providing access to the analytics platform for multiple users, a project management tool including a project definer and a task definer that makes project management resources available to a requestor user, an effectiveness rating tool providing an analytics effectiveness index for analytics provider users, and an auction management tool. The auction management tool allows the requestor user to specify an analytic task for auction, specify auction parameters and weighting of the auction parameters, and provide the specified analytic task for auctioning to ones of the multiple users, the specified analytic task having been defined in the task definer and related to a project defined in the project definer. The auction management tool receives bids on the specified analytic task from at least one of the analytics provider users; and provides received bids to the requestor user with scoring for each bid based on the parameters and the parameter weighting.

In an embodiment, each received bid provided to the requestor user is awarded a total score and is ranked based on the total score and the analytics effectiveness index for the analytics provider user submitting the bid.

The analytics effectiveness index may be calculated based on at least one of a robustness in an established area of inquiry and insight development. Alternatively or additionally, the analytics effectiveness index may be calculated based on at least two of the dimensions of construction, data, deliverable clarity, team diversity, transaction leverage, team effectiveness, delivery, velocity, longevity, and relative platform activity. Alternatively or additionally, the analytics effectiveness index may be calculated based on at least two of the sub-dimensions of: major factors and issues, convergence, divergence, analytic confidence, sanity check, group power, analytic confidence, completeness of data sets overall, completeness of meta data overall, completeness of atomic data sets, completeness of atomic meta data sets, deliverables provided, deliverables quality, outsiders viewpoint, activity rating, team leader view, team view, on time, on budget, extensibility, transaction rate, durability, applicability, and power user rating.

The project management tool may allow for an analytic project to be structured and managed throughout a project lifecycle, and may allow for organization of an area of inquiry and association of one or more hypotheses to the area of inquiry. The project definer may allow for definition of one or more projects associated with each hypothesis, and the task manager may allow for association of one or more analytic tasks to each project. The project management tool may further allow for a grant of access to artifacts associated with a task to ones of the plurality of users. Artifacts may include, for example, a problem description, evaluation criteria, an external data set, an internal data set, a statistical model study, a calculation procedure, and a listing of users who have roles within the area of inquiry.

Grant and removal of access privileges may be allowed in an established social network of users within the analytics platform. The analytics platform may be integrated with external social networks.

The analytics platform may optimize and route the processing of analytic activities. A user may identify an internal infrastructure to the analytics platform, and the analytics platform optimizes and routes the processing of analytic activities based in part on the identified internal infrastructure.

In another aspect, a non-transitory computer-readable medium includes executable instructions to set up an auction for an analytic problem, including specifying a plurality of award parameters and weights for respective ones of the award parameters, and receive multiple bids, each bid including bid information corresponding to the award parameters. For each bid, scores are established for respective ones of the award parameters based on the bid information, and weighted scores calculated for respective ones of the award parameters based on the scores and the weights for the respective ones of the award parameters. A composite score is calculated based on the weighted scores. Bids and the composite scores for respective ones of the bids may be displayed at a graphical user interface. A bid with the highest composite score may be identified.

The executable instructions to set up the auction may further specify an area of inquiry, data sets to be provided, and deliverable parameters, and may further specify at least one agreement to be executed by a bidder.

The award parameters may include a price, a delivery time, and an analysis approach. Scores may be established with respect to a common range across all the award parameters, and may be scaled with respect to the common range.

### BRIEF DESCRIPTION OF THE DRAWINGS

FIG. 1 illustrates one embodiment of a system in which an analytics platform may be implemented.

FIG. 2 illustrates an example of a computing device.

FIG. 3 illustrates a logical architecture of one embodiment of an analytics platform.

FIG. 4A illustrates an introductory auction page of one embodiment of an analytics platform.

FIG. 4B illustrates an introductory expert search page of one embodiment of an analytics platform.

FIG. 5 illustrates a team building page of one embodiment of an analytics platform.

FIG. 6A illustrates one example for a task-tracking page in one embodiment of an analytics platform.

FIG. 6B illustrates one example for presenting an Analytics Effectiveness Index in one embodiment of an analytics platform.

FIG. 7 illustrates one example of an auction tracking presentation format in one embodiment of an analytics platform.

FIG. 8 illustrates one example of an auction scoring presentation format in one embodiment of an analytics platform.

FIG. 9 illustrates one example of a statistics trending page in one embodiment of an analytics platform.

FIGS. 10A, 10B, and 10C illustrate portions of one example of a project management task definer in one embodiment of an analytics platform.

### DETAILED DESCRIPTION

A secure and scalable analytics platform includes a combination of techniques, tools, and metrics for organizing and solving analytic problems. The analytics platform uniquely organizes analytic problems into a hierarchy of areas of inquiry, hypotheses, projects, and questions. Associated to this hierarchy, which may evolve over time, are information artifacts to support problem solving. Artifacts include descriptions of one or more problems associated with the questions in the hierarchy, images, data to be analyzed, and metadata describing the data to be analyzed, among other artifacts. Collaborative teams and team members may be associated to the hierarchy. Team members may be discovered via external social networks, and may also be defined in an internal social network established on the analytics platform. The questions presented as one or more specific analysis tasks may be selectively posed along with associated artifacts to users of the analytics platform. Herein, the term ‘task’ refers to a single task or a set of bundled tasks. For example, the questions and artifacts, as well as portions or all of the hierarchy, may be provided via secure access methods to team members, service partners, or a pool of providers of expert analysis services or analysis resources. The analytics platform includes various tools and information resources for users of the platform. Tools include performance-improving training, community blogs that educate and inform on analytic topics, and project dashboards that provide status of projects and tasks.

Providers of analysis resources, and optionally tools made available by the provider of the analysis resources, are measured using an Analytics Effectiveness Index (AEI). The AEI is calculated uniquely for each analysis hierarchy based on a combination of metrics related to performance of analytic tasks, where the values of the metrics are determined from one or more of survey input, from measurable quantifiers, and from subjective review of performance. Some or all of the metrics may be calculated by the analytics platform, and the AEI is calculated by the analytics platform based on a formula related to the metrics. The AEI measures an overall value proposition for the execution and deliverables of the analytic work related to a task. The AEI dynamically monitors and measures the effectiveness of analytic problem solving as events and processing occur on the platform.

Embodiments of this disclosure are directed to an analytics platform which is implemented to address analytic challenges that are faced in terms of data size or format, problem complexity, and the desire to leverage information insights more effectively for competitive advantage. The platform provides some analytic functionality natively, and additionally connects analysis resources to those requiring analytic problem solving services. The platform leverages the power of social engagement within the context of complex analytic problem solving, and seeks to simplify the complexity of analytic problem solving by engaging a broad audience of skilled resources to provide improved speed to solution, insight, and cost effectiveness.

A challenge related to data is related to the exponential growth rate of incoming data. The “Internet of Things” is one example of a source of data abundance and exponential data growth. The “Internet of Things” refers to the interconnection of consumer and commercial devices, each of which has the capability to detect, sense and monitor objects, spaces, or entities; for example, the detection, sensing, and/or monitoring of persons, living and work spaces, vehicles, locations, and pets. As this data continues to grow, it provides valuable commercial and individual value as it can be analyzed independently or when combined with other data sets.

Available data also increases through combining publically available data sets with proprietary data sets. The volume of data available further increases as privacy barriers loosen, and more people and corporations are willing to minimize their privacy concerns for the promise of what predictive analytics and other analysis techniques could provide them. Some examples include the promise of accelerated drug discovery and research findings, more targeted advertising, and cost reduction through more pinpoint targeting of marketing, sales, and customer service.

Another challenge related to data is the presence and abundance of unstructured data, including pictures, blogs, blobs, texts, web logs, geospatial data, and other non-indexed data.

Traditional data warehousing techniques are not well suited for analyses of this changing landscape of data. A typical large corporate computing infrastructure may include multiple transactional application systems (e.g., accounting systems, human resources (HR) systems, web site usage data capture systems), augmented by data extraction tools (e.g., Extract, Transform, Load—ETL) to pull data to data warehouses. In the warehouses, the data is reorganized for business intelligence and for reporting and analysis. Data reorganization includes, for example, data cleansing, pattern recognition, aggregation, filtering, drill down, data mining and predictive analytics. Overwhelming data growth rates along with unstructured data formats are taxing the ability of traditional data analytic techniques. Thus, new data management tools have been, and are being, developed.

For example, Hadoop is an open source ecosystem and set of utilities that can ingest and analyze unstructured and structured data sets at about ten times (10×) faster rates than traditional data warehousing techniques. There are several options emerging for employing a Hadoop ecosystem, which include natively using the Open Source Hadoop Software, or leveraging an Open Source Vendor such as Horton Works or Cloudera. Traditional Business Intelligence and database vendors like IBM, HP, Oracle, and Microsoft are combining their existing relational and Business Intelligence solutions with proprietary Hadoop implementations. Many of these analytic solutions are expensive and require a commitment to either develop internal expertise or a commitment to a specific vendor solution. Standard solutions are not available at this time, creating a challenge to selecting a vendor solution that will be useful and relevant in the long term. Developing internal expertise is a challenge as well, as data analytics work is complex and can demand the need for experts such as statisticians, data scientists, operations analysts, reporting experts, and domain experts. However, there are a limited number of such experts available across these talent pools. Further, although some expert skill sets are applicable across industries, some expert skill sets are domain or industry specific, further limiting the talent pools. Thus, it may not be possible or practical to find and hire experts to build internal expertise. Additionally, there may not be a steady or sustainable internal need for experts that supports the hiring of the experts directly.

The analytics platform of this disclosure provides those in need of Analytic Expertise an access to talent pools for specific tasks, and provides experts in the talent pools an access to available tasks appropriate for their talents and expertise. The analytics platform further provides tools for more cost effective and comprehensive analytic resources and solutions. The analytics platform provides scalability, simplifying analytics for the biggest to the smallest challenges, for all industries, and for any size organization. Simplification in the approach for analytic problem solving is important due to conditions created by exponential data growth, and shortages of analytic data science talent and domain expertise. An organization such as a corporation may not be fully resourced with all of the skills necessary to do complex, high volume, or high velocity analytic problem solving; but may understand what problems the organization is trying solve and what questions to ask. The integrated problem definition and project management capabilities of the analytics platform allow for more effective collaboration techniques, which are monitored and measured for effectiveness and improvement at scale.

The analytics platform provides the AEI for providers of analytic services, and optionally for requestors of analytic services. The AEI recognizes that there is often no right or wrong answer for a particular analytic problem, and an investigation may produce new questions that demand more data and continued refined analyses. For example, the quality of analytic insight can be as important as the cost or time to produce the insight, and the AEI thus may include a measure of the quality of insight.

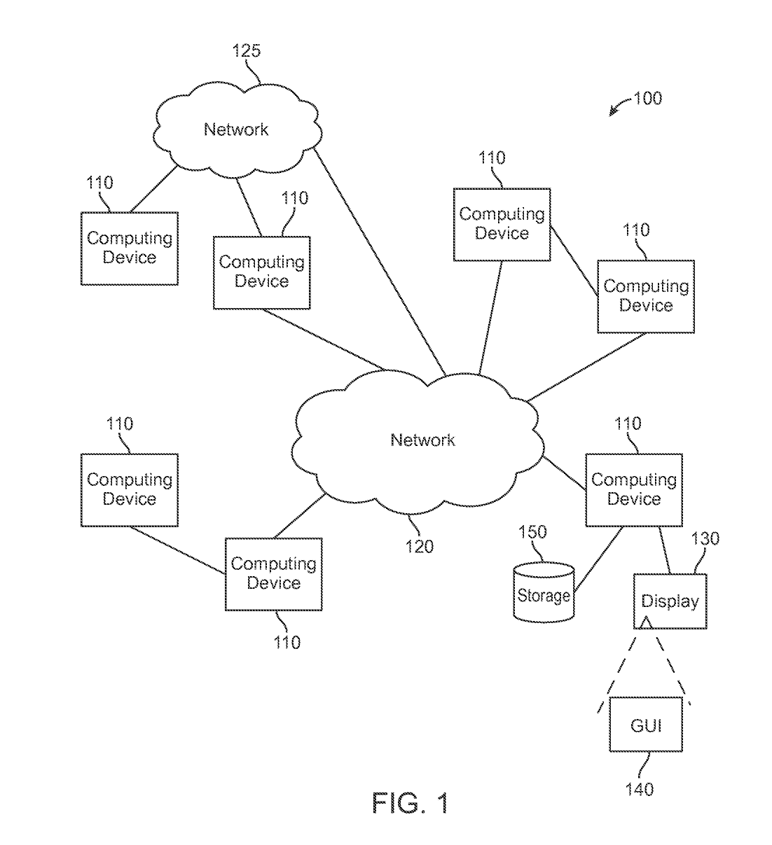

FIG. 1 illustrates an example of a system 100 in which the analytics platform of this disclosure may be implemented. System 100 includes multiple computing devices 110, and networks 120 and 125. Components of system 100 can realize various different computing model infrastructures, such as web services, distributed computing, cloud computing, and grid computing infrastructures.

Computing device 110 may be one of many types of apparatus, device, or machine for processing data, including by way of example a programmable processor, a computer, a server, a mobile device such as a smart phone or a tablet, a system on a chip, or multiple ones or combinations of the foregoing. Computing device 110 may include special purpose logic circuitry, such as an FPGA (field programmable gate array) or an ASIC (application-specific integrated circuit). Computing device 110 may also include, in addition to hardware, code that creates an execution environment for a computer program, such as code that constitutes processor firmware, a protocol stack, a database management system, an operating system, a cross-platform runtime environment, a virtual machine, or a combination of one or more of the foregoing.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a network, such as network 120 or 125.

Networks 120 and 125 represent any type of network, or a combination of networks. Networks 120 and 125 may include one or more of analog and digital networks, wide area and local area networks, wired and wireless networks, and broadband and narrowband networks. In some implementations, network 120 and/or network 125 may include a cable (e.g., coaxial metal cable), satellite, fiber optic, or other transmission media.

As illustrated in FIG. 1, computing device 110 may be in communication with another computing device 110 directly, or via one or more networks 120 and/or 125.

One computing device 110 of FIG. 1 is illustrated as being in communication with a display 130 having a graphical user interface (GUI) 140, and further illustrated as being in communication with a storage 150. Although one computing device 110 is illustrated as being in communication with display 130 (with GUI 140) and storage 150, other computing devices 110 may also be in communication with one or more displays 130 and one or more storages 150. Further, displays 130 and storages 150 may be shared by more than one computing device 110.

Display 130 is a viewing device such as monitor or screen attached to computing device 110 for providing a user interface to computing device 110. GUI 140 is a graphical form of user interface. Functions of the analytics platform of this disclosure may be provided to GUI 140 for presentation to a user. There may be more than one GUI 140 implemented, such as one for larger displays 130 and one for smaller displays 130. A GUI 140 may be configured to display different information for different users.

Storage 150 represents one or more memories external to computing device 110 for storing information, where information may be data or computer code.

At least some functions of the analytics platform of this disclosure may be implemented as non-transitory computer-readable instructions in storage 150, executed by computing device 110.

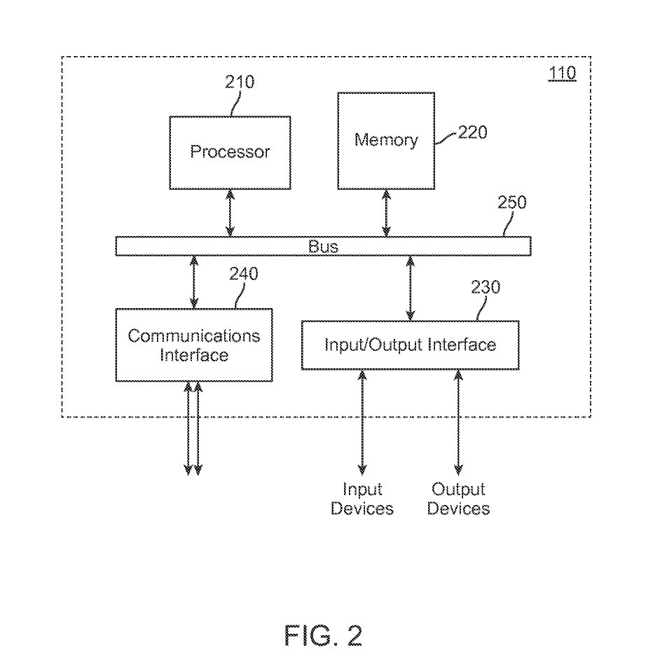

FIG. 2 illustrates an example of a computing device 110 that includes a processor 210, a memory 220, an input/output interface 230, and a communication interface 240. A bus 250 provides a communication path between two or more of the components of computing device 110. The components shown are provided by way of illustration and are not limiting. Computing device 110 may have additional or fewer components, or multiple of the same component.

Processor 210 represents one or more of a processor, microprocessor, microcontroller, ASIC, and/or FPGA, along with associated logic.

Memory 220 represents one or both of volatile and non-volatile memory for storing information. Examples of memory include semiconductor memory devices such as EPROM, EEPROM and flash memory devices, magnetic disks such as internal hard disks or removable disks, magneto-optical disks, CD-ROM and DVD-ROM disks, and the like.

At least some functions of the analytics platform of this disclosure may be implemented as computer-readable instructions in memory 220 of computing device 110, executed by processor 210.

Input/output interface 230 represents electrical components and optional code that together provides an interface from the internal components of computing device 110 to external components. Examples include a driver integrated circuit with associated programming.

Communications interface 240 represents electrical components and optional code that together provides an interface from the internal components of computing device 110 to external networks, such as network 120 or network 125.

Bus 250 represents one or more interfaces between components within computing device 110. For example, bus 250 may include a dedicated connection between processor 210 and memory 220 as well as a shared connection between processor 210 and multiple other components of computing device 110.

An embodiment of the disclosure relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

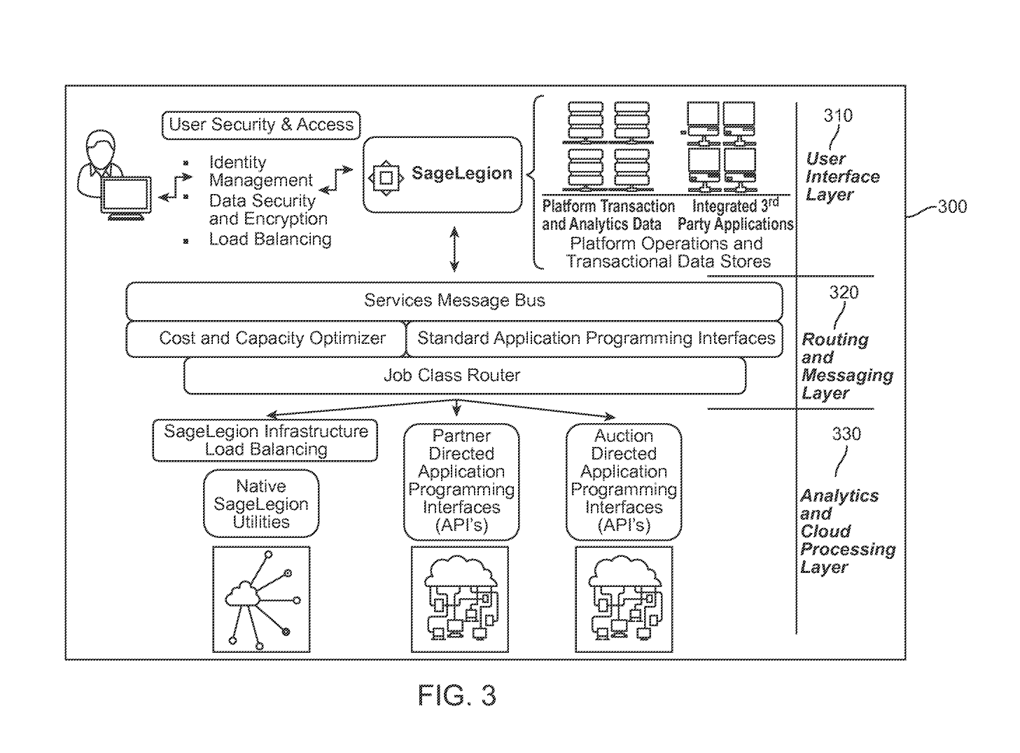

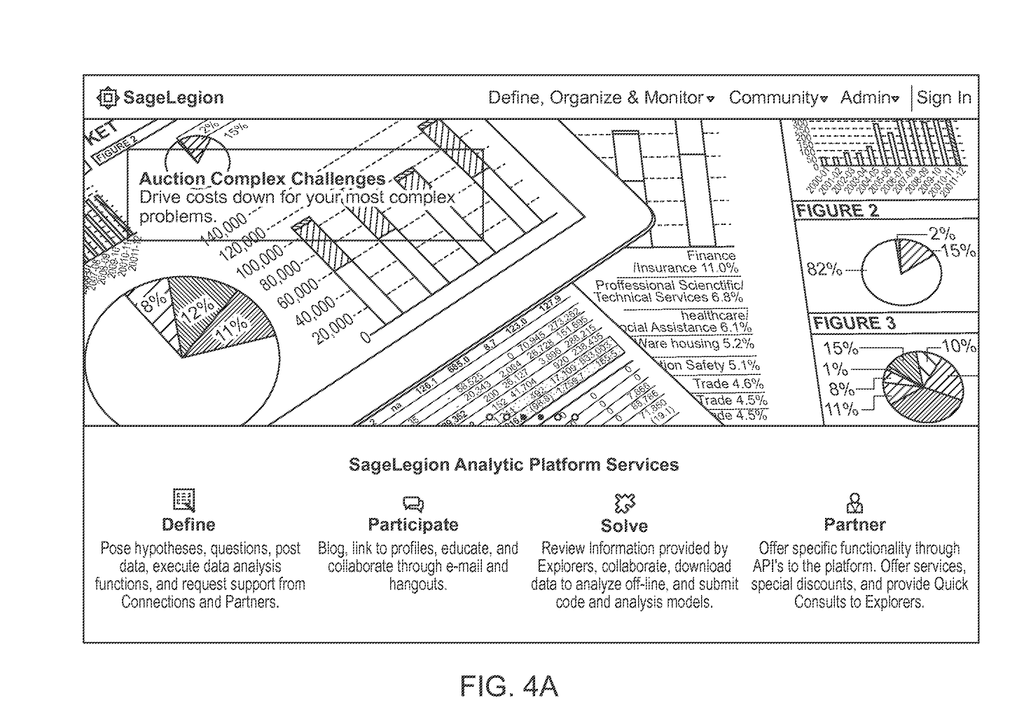

FIG. 3 is a representation of a logical architecture 300 for one embodiment of an analytics platform according to this disclosure. The analytics platform of the embodiment represented by FIG. 3 is named SageLegion. At least portions of the SageLegion architecture are applicable generally to an analytics platform according to this disclosure. Three architecture layers are illustrated in FIG. 3 for the SageLegion platform: a User Interface Layer 310, a Routing and Messaging Layer 320, and an Analytics and Cloud Processing Layer 330.

User Interface Layer 310: A user interfaces with the analytics platform (e.g., SageLegion in the embodiment of FIG. 3) when an associated platform site is accessed (e.g., a web site in the World Wide Web on the internet, or a site on an intranet). A user interface includes hardware, firmware, and software for communication between the analytics platform and a user's computing device. The user interface may include a GUI. A portion of the user interface software may be provided in near real time by the analytics platform, or may be installed in full or in part on a user's computing device. User Interface Layer 310 includes user security and user access control. The analytics platform includes security functions such as identity management, validation, data security, and load balancing functions, that ensure that a user is who they say they are and that submitted data and other information is done so in a secure manner. Security functions are illustrated by way of example in FIG. 3 as a ‘User Security & Access’ tool included in the SageLegion platform.

User Interface Layer 310 further provides Platform Operations and Transactional Data Stores. As illustrated, this feature includes ‘Platform Transaction and Analytics Data’ and ‘Integrated 3rd party Applications’. Platform Transaction and Analytics Data includes transactional data that allows the platform to operate, such as user credentials, analysis hierarchies, established social networks, and relationship data. The data may be organized by transaction, based on the activities of a user on the analytics platform. Platform Transaction and Analytics Data also includes, for example, platform event logging and trending, cost tracking, third party platform descriptive job catalogs, and user experience data. Integrated 3rd party Applications include third party applications integrated directly into the analytics platform functionality. Such third parties can be analytic service providers and partners with unique and proprietary analytic services to offer for data survey, data cleansing, statistical analysis, predictive modeling, or reporting, for example. Such third party applications include Google and LinkedIn identity management, Gmail, Hangouts, and Google+ video conferencing, among others.

Routing and Messaging Layer 320: The Routing and Messaging Layer 320 of the SageLegion platform includes a Services Message Bus, a Cost and Capacity Optimizer, Standard Application Programming Interfaces, and a Job Class router. The purpose of the Routing and Messaging Layer 320 is to allow for an asynchronous user experience on the SageLegion platform. User Layer 310 provides for an on-line, real time and synchronous user experience with the SageLegion platform. Service and transactional requests can be established through the user interface layer 310. Many analytical service requests, however, require significant processing time. To optimize the user experience, the Services Message Bus queues up requests for selected platform operations established in User Layer 310, the processing of the requests, and reporting on the requests. The requests are in the form of messages that identify programs to be executed, data to use, time to begin execution, and where to store results, messages, and errors. The Cost and Capacity Optimizer accesses processing catalogs to determine the most effective times and third party platforms for processing specific analytic tasks. The Standard Application Programming Interfaces support electronic interfaces between the analytics platform and third party vendor platforms for vendors that have entered into business partnerships. The Job Class router uses other messaging components to route data and messages between the various parts of the analytics platform, and will also handle error processing and reporting to the Services Message Bus for management of incomplete transactions.

Analytics and Cloud Processing Layer 330: The Analytics and Cloud Processing Layer 330 includes a user data landing pad that holds user data that has been submitted or provided access to in order to solve one or more analytic problems. Defined via instructions and parameters provided by the Services Message Bus in Layer 320, asynchronous processing occurs in the background and separate from the user experience in Layer 310. This background processing is provided by analytics processing components (e.g., Hadoop components), data warehousing, data mining, business intelligence and analytic services orchestration native to the analytics platform, users, or third party proprietary service providers. Services are executed in the Analytics and Cloud Processing Layer 330 with results posted and the user alerted via Layer 310 when completed. For a user that utilizes the native analytic processing capabilities, the processing components of Analytics and Cloud Processing Layer 330 provide the infrastructure upon which the processing will take place. A user that accesses infrastructure of a service provider for performing analytics accesses the service provider's infrastructure through Analytics and Cloud Processing Layer 330.

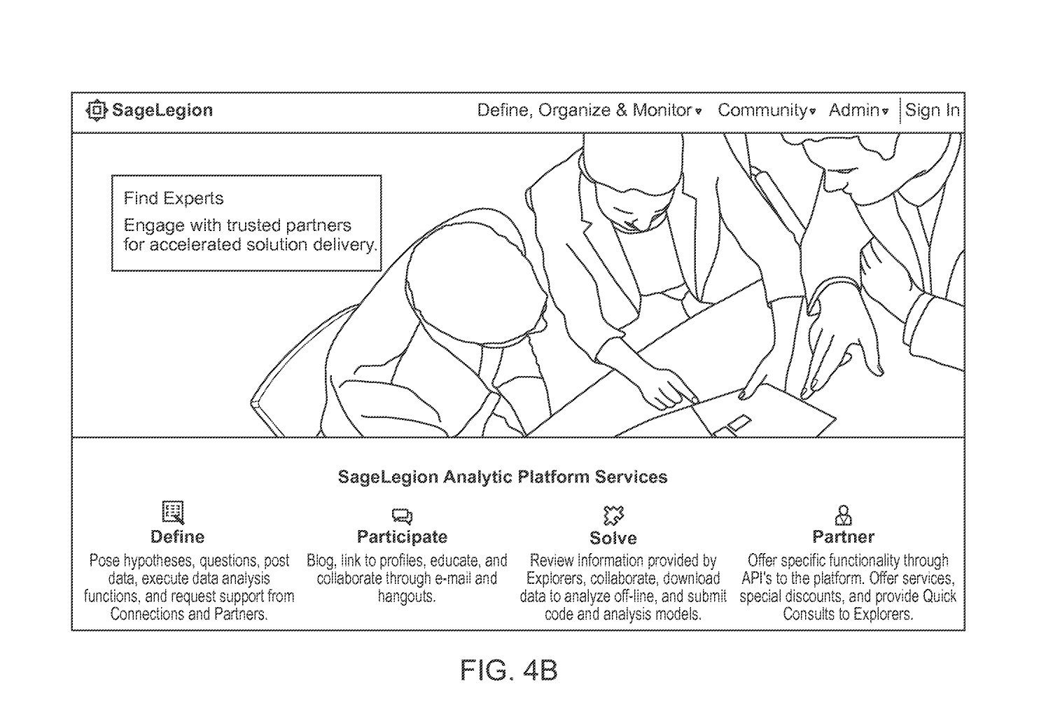

By way of introduction to a more detailed description of an analytics platform in accordance with this disclosure, screenshots from the SageLegion platform are provided in FIGS. 4A-4B. FIG. 4A illustrates an introductory page for an auctioning feature for auctioning complex analytic problems, and FIG. 4B illustrates an introductory page for an expert-finding feature. Other features may also be included in an analytics platform in accordance with this disclosure, and additional pages provided to access the features.

When a user signs up for an account on the analytics platform, the user may be requested to establish credentials, preferences, and passwords. In some embodiments, for example when the analytics platform is deployed for use internally within an organization, some credentials, preferences and passwords may not be used. If a user represents a group of users, such as a corporation, then the credentials, preferences, and passwords may be applicable for the group, and individuals within the group may use these credentials, preferences, and passwords, or the group access may be defined such that each individual may establish one or more of credentials, preferences, and passwords separately. Preferences may include communication preferences, such as email, phone and text access channels to associate with the account, as well as preferences for interacting with the analytics platform and with other platform users.

After account setup, at subsequent logins, a user's credentials are verified.

The analytics platform may display and promote advertising from other platform users, where the advertising may be general or may be targeted, and may be distributed to all platform users, to a particular subset of users, or to other users with specific business development agreements.

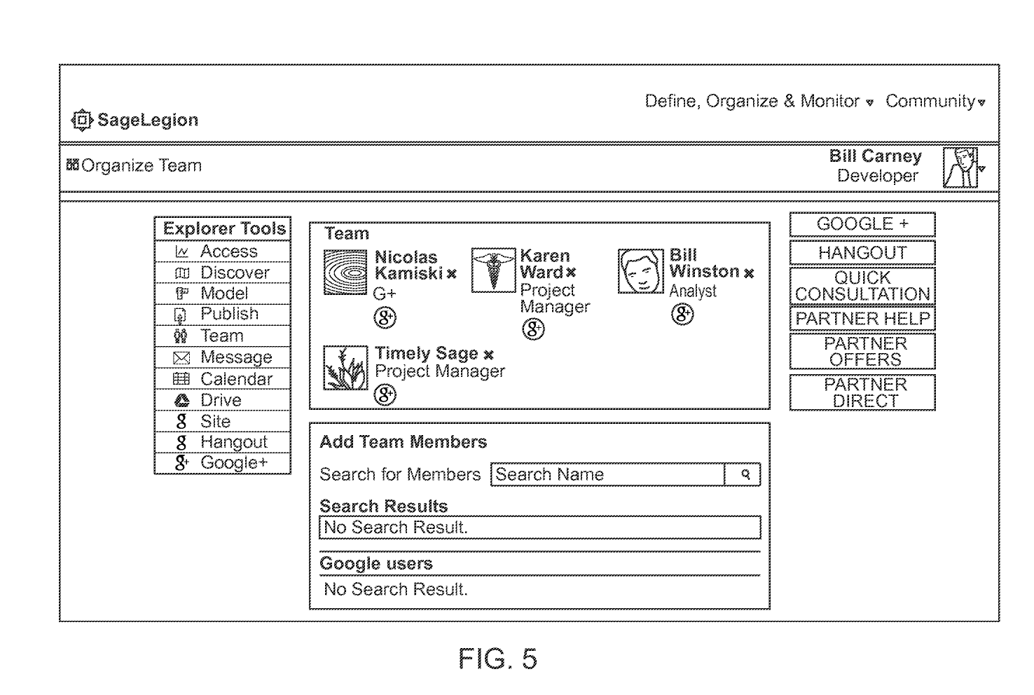

The analytics platform provides a variety of social networking functions to platform users. A community engagement function, for example, may provide a variety of information about analytics, the analytics industry, trends, and information, and may include blogs, educational information, current research, and various germane RSS feeds, among other information. A connection function may provide, for example, the ability to search for and identify key individual or group resources participating in the analytics platform, where searches include the ability to view profiles, capabilities, and service offerings. A collaboration function may provide, for example, the ability to search for and select specific individual or group users to collaborate on areas of inquiry, and add the individuals or group users to a team. An example is provided in FIG. 5 for the SageLegion platform. A partner evaluation function may provide, for example, the opportunity to peruse offers and capabilities of other users of the analytics platform, such as identification of specific services, costs, and available application programming interfaces (APIs).

The analytics platform further provides several functions to allow users to outline and manage analysis work, whether the analysis work is to be self-performed (e.g., in-house), or is to be performed by another party, such as another user of the analytics platform.

For convenience and not by way of limitation, users are described herein going forward as Partners, Requestors, and Providers. Partners refer to users having between themselves a formal or informal arrangement, such as a contract or an employment relationship. Requestors refer to users having an analytic task for which an Analytic Expert is needed. Providers refer to users (individual or group) having an expertise or resource that may be used for analytic tasks. Providers are further distinguished as Analytic Expert Providers, referring to users having human resources for performing analytic tasks, and Analytic Resources Providers, referring to users having non-human resources for performing, or supporting the performance of, analytic tasks. A user may be one or more of Partner, Requestor, or Provider at any given time, and may be a Requestor for one analytic task while being a Provider for another analytic task. For example, a Requestor may be a Partner with one or both of an Analytic Expert Provider having human expert resources and an Analytic Resources Provider having non-human resources for the Analytic Expert Provider to use in performing an analytic task. In this example, the task-associated Analytic Expert Provider and Analytic Resources Provider may or may not be Partners with each other. A Provider may be both an Analytic Expert Provider and an Analytic Resources Provider.

The analytics platform includes a project management tool providing a structure within which to plan, define, and organize a hierarchy, which can then be managed throughout its lifecycle. The project management tool includes a structure definer, which allows a user to establish the hierarchy such as area of inquiry, hypotheses, projects, and questions. An area of inquiry may be entered manually, or selected from a menu that may be optionally provided. One or more hypotheses may be presented for each area of inquiry. Multiple projects may be associated with each hypothesis or area of inquiry. Multiple questions may be associated with each project.

The project management tool also allows for the control and management of a hierarchy, and control of access to associated artifacts and data. The hierarchy becomes the basis for aligning artifacts to allow analytic problem solving. These artifacts include problem descriptions, evaluation criteria, external (public) and internal data sets, statistical model studies, calculation procedures, and an associated social network of support personnel who have roles within the particular area of inquiry. The project management tool allows a user to grant or remove access privileges in an established social network within the analytics platform. Such an internal social network is enabled by integration with external social networks (e.g., Google+ and LinkedIn). Through the internal social network, individuals may be identified and associated to a team and a hierarchy.

The project management tool may include a project definer which allows a user to define projects within a hierarchy, and a task definer which allows a user to define tasks related to questions within a hierarchy. Portions or all of an analytic task may be defined to be performed either with manual oversight or in an automated fashion. The project management tool may also allow a user (e.g., a Requestor) to leverage specific tools that allow for the association of data sets, team members and output products to support tasks of a defined project.

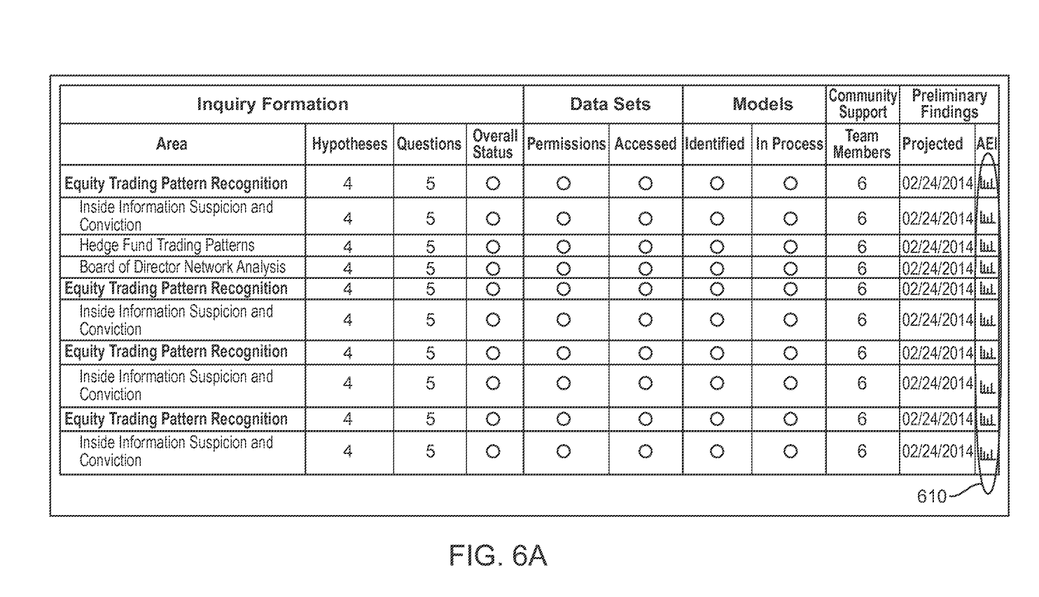

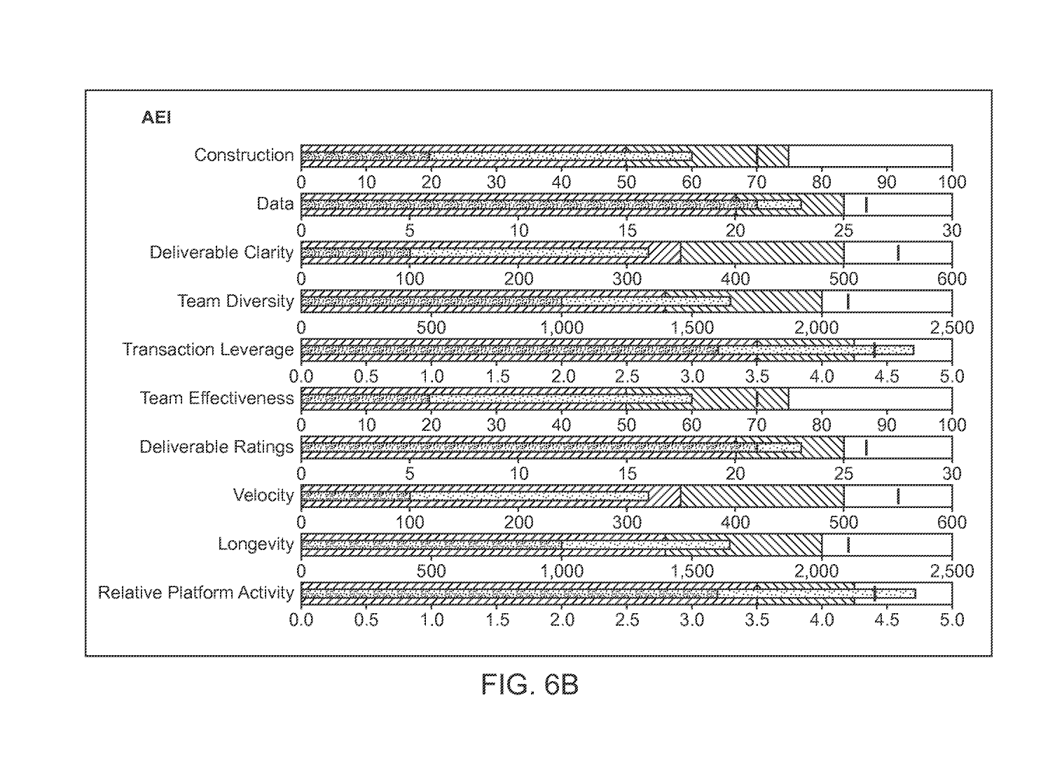

The project management tool further may include a task manager, which provides indications of the status of one or more analysis tasks. Multiple status indicators may be provided, such as whether data has been secured, a team has been engaged, and what is/are the next due date(s). One example of how status identifiers may be presented is illustrated in FIG. 6A. In this example, the column circled and labeled as 610 is a column of links to AEI ratings for the associated tasks. FIG. 6B illustrates an AEI reached by selecting one of the links.

The analytics platform may provide optimization and routing tools, for optimizing and routing the processing of analytic tasks. Using the provided tools, tasks may be optimized for lowest cost processing or for the most efficient processing infrastructure. For example, a task may include that a map reduce analysis be processed on a data set associated to an area of inquiry, and the optimization and routing tools provision and spin up cost-effective analytics processing infrastructure, control the performance of the analysis, post results, shut down the processing infrastructure, and create log files.

The analytics platform may allow users to identify internal infrastructure to the analytics platform. For example, a corporation may have a Hadoop or Data Warehousing infrastructure in house that they make know to the analytics platform. The optimization and routing tools of the analytics platform can then take these additional computing resources into account when routing for analytic processing by other users on the platform. Identifying available resources for use within the analytics platform creates a new revenue stream for the user and/or provides a reputational boost to the corporation. For example, a large health system runs research analyses for a variety of smaller hospitals, thereby creating revenue for the large health system while reducing the cost of research for the smaller hospitals.

The analytics platform includes an auction management tool, for the case that a Requestor seeks assistance in performing an analytic task or set of tasks. The Requestor can leverage the social networking aspects of the platform to provide informational material about the analytic task or set of tasks to other users. Informational materials may include the hierarchy defined in the structure definer, one or more projects defined in the project definer, one or more tasks defined in the task definer, outlines, data, models to be used, and desired outputs such as reports, analysis models, visualizations, code, and next steps analyses. Informational materials may further include sets of legal or contractual documents that are expected to be executed by a selected Provider, such as non-disclosure agreements, intellectual property assignments, business associate agreements, data use agreements, and a statement of authority to execute contracts. The informational material may be provided to categories of users, to all Partners, or to selected users or selected Partners.

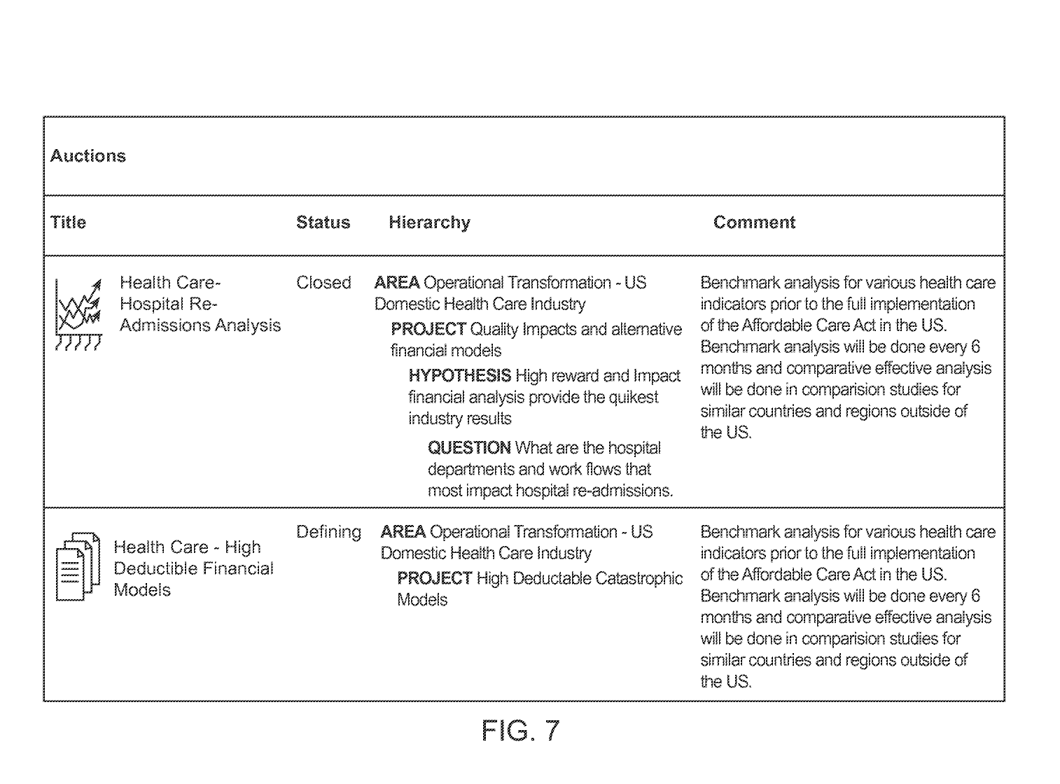

A formal or informal auction may be established through the auction management tool, such that there may be a timed auction of tasks, or a time frame in which to submit bids (and rebids), or an auction that continues until the Requestor elects to close the auction. Auctions may be tracked. One example of how auction status may be presented is illustrated in FIG. 7.

The auction management tool includes a bid evaluator, which scores bids received from Providers based on parameters such as price, delivery timeframe, and analysis approach, for example. Other parameters may additionally or alternatively be used to score bids, and the parameters may be weighted, where weighting values may be established as defaults on the analytics platform and may be modified by Requestors before, during, or after an auction. Scores for individual parameters may be automatically awarded, or may be added by the Requestor. For example, price and delivery timeframe may be automatically scored, whereas analysis approach may be scored by the Requestor. For another example, a set of analysis approaches may be predefined and ranked by the Requestor, and an analysis approach parameter automatically scored based on the approach selected. Price may be scored on absolute price (e.g., with various price ranges pre-specified), by price normalized with respect to the bids received, or by price deviation from an expected price or an average price of bids received (e.g., with various ranges of deviation pre-specified). In the event that price deviation is used for scoring, both positive and negative scores may be used. In one example, the range of bid prices is normalized or scaled to a range of scores from 0 to 10.00, with a lowest bid assigned to a score of 10.00, a highest bid assigned to a score of 0, and with intermediate bids assigned to intermediate scores between 0 and 10.00. Delivery timeline may be scored based on absolute time, normalized time, or time deviation from an expected or average value, similarly to the price scoring described above.

Bids in an auction are provided to the Requestor with or without individual parameter scores, and with or without total scores. Total scores may be calculated by a weighted formula or other formula. One example of a total score calculation is: Total score=(price score×price weight)+(delivery score×delivery weight)+(analysis score×analysis weight).

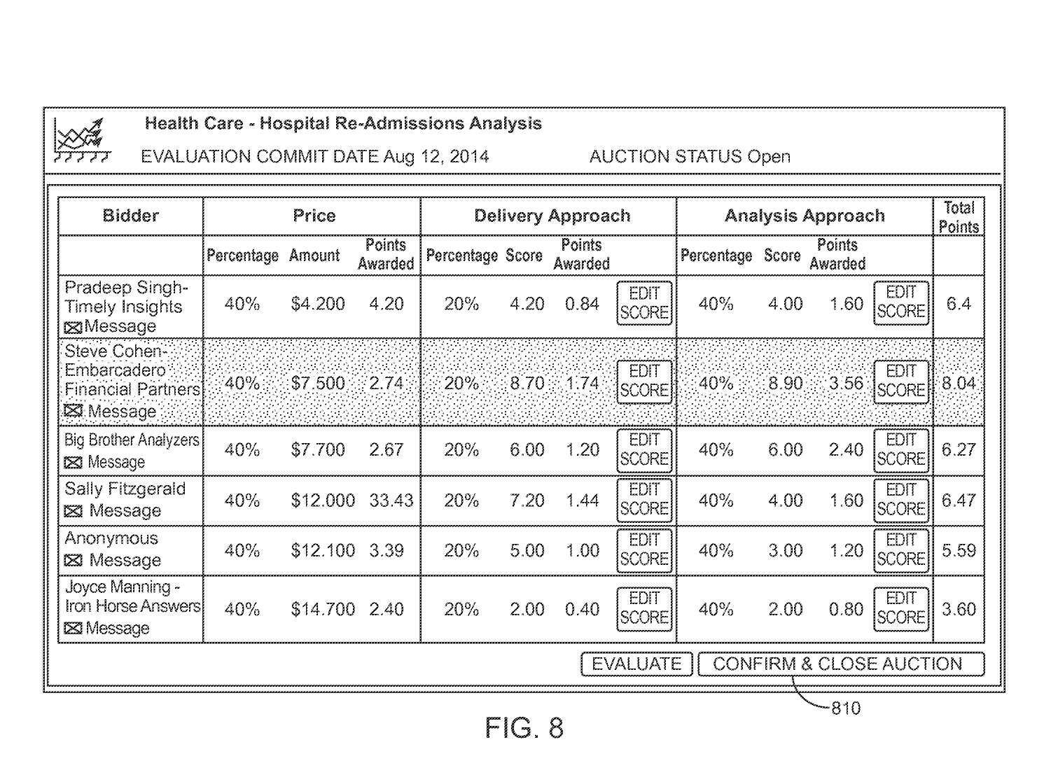

Bids may be ranked in an order by total score, by one of the parameter scores, by order of bid receipt, by geographical distance between the Requestor and Provider, alphabetically, in another order, or randomly. The bids may be provided to the Requestor anonymously to avoid influence of selection based on name. One example of how bids may be presented is illustrated in FIG. 8. In this example, the auction may be kept open until the “Confirm & Close Auction” button 810 is selected.

In one example, a Requestor may define an auction, and an Analytic Expert Provider may prepare a bid based on using available resources of one or more Analytic Resources Providers for performing the analysis. The proposed use of resources of the Analytic Resources Provider(s) may be disclosed to the Requestor for use in selection of a winning bid, or may be kept confidential as between the Analytic Expert Provider and the Analytic Resources Provider(s).

The analytics platform includes tools for Providers, such as the capability to search for listed auctions, review the material that describes the auction, place a bid on an auction (e.g., submit pricing and delivery timeline, with analysis approach documents and proposals), monitor auctions in process, update a bid in an ongoing auction, and review bid history for closed auctions. A Requestor may disallow access to certain functions, such as bid updates or reviews of closed auctions.

Although auctions have been described in terms of winning bids, the analytics platform also provides for the selection of multiple Providers to perform a task. For example, by selecting multiple Analytic Expert Providers using different analysis approaches, a Requestor may identify further areas of investigation, or may be able to focus in on a specific area of investigation uncovered by analysis from different viewpoints. For another example, a comparison of analytics using the infrastructure from different Analytic Resources Providers may indicate one infrastructure particularly suited to the specified analytic task.

The auction management tool provides a Requestor with the option to display an amount budgeted for the auctioned task, and whether or not a bid over this amount will be accepted. The Requestor may select to see all bids, or may select to see only those bids that do not exceed the specified budget.

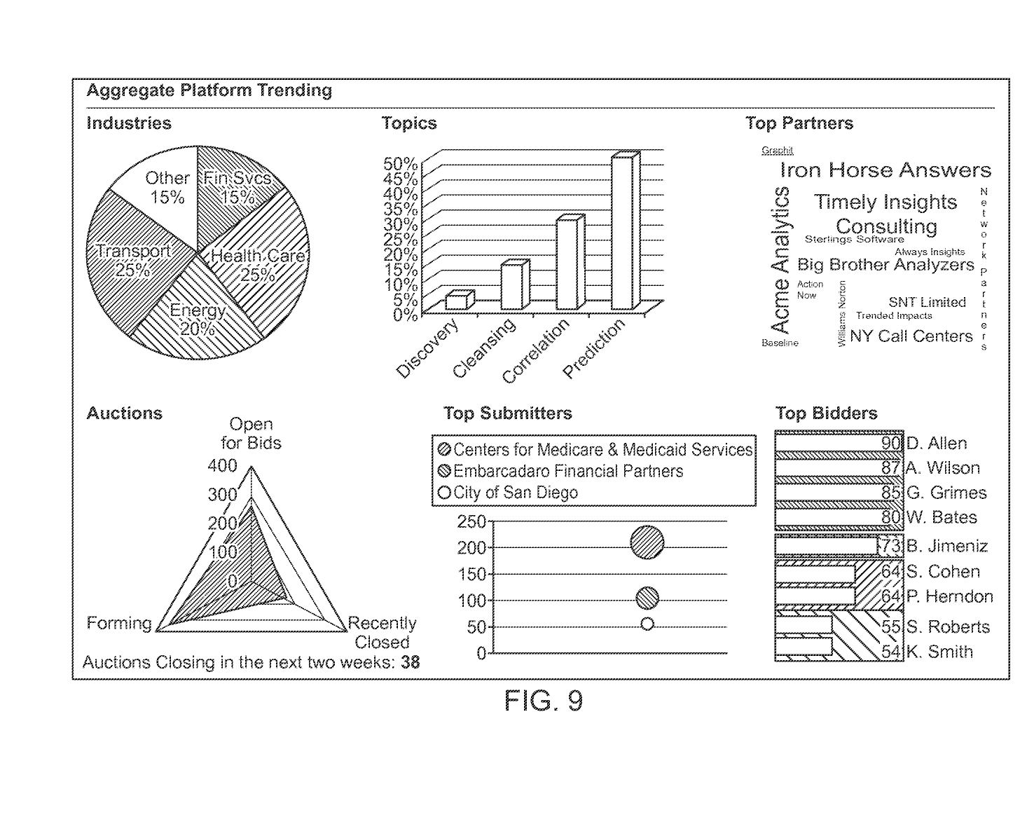

In addition to the functions described above, the analytics platform further includes a Workbench, which provides platform statistics on what services Requestors are buying overall, and specifically from platform user offerings. Overall platform trends for services may be provided as well as what marketing campaigns are yielding. One example of information that may be provided within a Workbench is illustrated in FIG. 9.

The analytics platform provides users the option of paying for services with chits. The term ‘chit’ herein refers to the use of debits/credits not related to an established currency. For example, Partners in the analytics platform may exchange use of analytic resources for access to sources of data, and Providers may exchange hours of Analytic Expertise for an opportunity to advertise their expertise on a Requestor's website. Further, chits may be used as a tracking mechanism for the transactions occurring in the analytics platform. For example, within a corporation or organization, management may track which resources are being used, how often they are used, and who is using them by tracking the chits.

The analytics platform provides an effectiveness rating tool, which generates an AEI for Providers, and optionally for Requestors of analytic services. For Providers, the AEI is a measure of, for example, the quality of work of an Analytic Expert Provider or the quality of service of an Analytic Resources Provider. For Requestors, the AEI is a measure of, for example, how close the final task description is to the initial task description provided, the number of times a task was redefined, the relationship between task redefinition and amount paid, the timeliness of provision of related materials, and the speed at which invoices are paid.

The AEI of a Provider (or Requestor) may be provided where available, or may be provided upon payment of an additional fee. The AEI may appear next to a Provider name on a search page, or with a bid on an auction status page, for example. A Requestor may use the AEI to further rank bids in an auction, and the AEI may be a parameter used in the scoring of bids in an auction.

In one implementation, the AEI for a Provider includes two or more effectiveness rating dimensions, such as: construction, data, deliverable clarity, team diversity, transaction leverage, team effectiveness, delivery, velocity, longevity, and relative platform activity. Each dimension is accorded an index, and the indices of the dimensions combined to form the AEI using a formula, which may include weighting of the dimensions. In each dimension there may be sub-dimensions, which may contribute to the index for the parent dimension, and the sub-dimensions may be weighted in determining the index for the parent dimensions, which may themselves be weighted in determining the AEI.

Construction: The construction dimension refers to how comprehensively an area of inquiry has been established. Sub-dimensions may include, for example, ‘major factors and issues’, ‘convergence’, ‘divergence’, ‘analytic confidence’, ‘sanity check’, and ‘group power’. The ‘major factors and issues’ sub-dimension refers to one or more artifacts created that articulate major factors or issues about an area of inquiry. This sub-dimension may be particularly useful if the area of inquiry selected in the project definer is selected from a menu of pre-defined options. Measurement of this sub-dimension may be binary (e.g., an artifact exists or not) or otherwise discrete values (e.g., exists or not, or was influential in creating the hierarchy in the project definer), or non-discrete values (e.g., the percentage of artifacts in a data store from this Provider related to this area of inquiry). The ‘convergence’ sub-dimension refers to one or more artifacts created that demonstrate an assessment of the project or task structure that allows for focusing of the project or task, such as by eliminating alternative solutions. The ‘divergence’ sub-dimension refers to one or more artifacts created that demonstrate a broadening of the view of the project or task, such as by gathering more evidence or entertaining multiple alternatives. Measurement of the convergence and divergence sub-dimensions may be similar to measurement of the major factors and issues sub-dimension, namely binary, discrete, or non-discrete values.

The ‘analytic confidence’ sub-dimension relates to confidence in the results or confidence in the judgment necessary for a task. Measurement of the analytic confidence sub-dimension may be discrete, such as, for example, one of the four measures simplistic, deterministic, random, indeterminate, where: ‘simplistic’ indicates that it is factual and there is only one answer; deterministic indicates that there is only one answer but the correct formula must be used; random indicates that different answers are possible and all can be identified; and indeterminate indicates that different answers are possible but are conjectural, so not all can be identified. In this measurement structure, simplistic and deterministic tasks indicate reliance on facts such that there is more confidence in the findings, whereas random and indeterminate tasks rely on judgment and thus have more probability of error. The ‘sanity check’ sub-dimension is an intuitive indication whether a problem description is well structured or not, and may be measured, for example, in binary form (e.g., right or wrong). The ‘group power’ sub-dimension refers to a team environment where the team as a whole may be stronger than its individual members. The measure of group power may be derived from the associated team structure and how often the team members sign in or look at a problem they are seeking to solve, such that the whole team is active, not just a portion of the team. For example, a measurement may be discrete (e.g., six or more active team members; three to five active team members; two or one active team members).

Data: The data dimension refers to the completeness of the data artifacts associated to the area of inquiry and problem hierarchy. Sub-dimensions may include, for example, ‘completeness of data sets overall’, ‘completeness of meta data overall’, ‘completeness of atomic data sets’, and ‘completeness of atomic meta data sets’. The ‘completeness of data sets overall’ sub-dimension refers to whether all of the necessary data sets are present along with their associated meta data. The ‘completeness of meta data overall’ sub-dimension refers to whether each data set has an associated meta data file. The ‘completeness of atomic data sets’ sub-dimension refers to whether each data set has an associated complete data file. The ‘completeness of atomic meta data sets’ sub-dimension refers to whether each data set is complete and cleansed per the meta data definitions. Measurement of the sub-dimensions of the data dimension may be, for example, binary (e.g., yes or no) or discrete (e.g., yes, partially, or no).

Deliverable clarity: The deliverable clarity dimension refers to the quality of the analysis specific to the deliverables requested. Sub-dimensions may include, for example, ‘deliverables provided’ and ‘deliverables quality’. The ‘deliverables provided’ sub-dimension refers to whether each requested deliverable is provided, and may be measured in binary (e.g., yes or no) or discrete (e.g., yes, partially, or no) form. the ‘deliverables quality’ sub-dimension refers to a subjective rating of the deliverables as a whole, and may be measured in binary (e.g., acceptable or not acceptable) or discrete (e.g., rating of 1 to 5) form.

Team diversity: The team diversity dimension refers to how many, and how many different, team members and team member skills are associated to the problem hierarchy. Sub-dimensions may include, for example, ‘outsiders viewpoint’, which refers to whether a non-primary member of the team has been active on the team in the last thirty days (or other time frame). The ‘outsiders viewpoint’ sub-dimension indicates whether “fresh eyes” have looked at the progress on the specified task. Measurement of this sub-dimension may be binary (e.g., yes or no) or discrete (e.g., number of non-primary team numbers).

Transaction leverage: The transaction leverage dimension refers to a comparison of a users' problem to other similar problems. Sub-dimensions may include, for example, ‘activity rating’, which refers to how many other users of the platform may be engaged in similar types of problem solving and if that is being leveraged. The ‘activity rating’ sub-dimension is an indication of external tipping points and internal and external awareness in a particular area. Measurement of this sub-dimension may be discrete, related to the number of transactions on this problem and on similarly coded problems for all users on the analytics platform (e.g., low volume less than five transactions, high volume more than five transactions, or very high volume more than ten transactions). The measurement may be further refined to reflect whether the transactions are loosely related (e.g., in the same area of inquiry) or closely related (e.g., the specific task is similar).

Team effectiveness: The team effectiveness dimension refers to how the team associated to a problem hierarchy self-assesses their performance. Sub-dimensions may include, for example, ‘team leader view’ and ‘team view’. The ‘team leader view’ sub-dimension refers to a subjective rating of the team by the team leader, whereas the ‘team view’ sub-dimension refers to a subjective rating of the team by individual team members. Measurement of the sub-dimensions may be, for example, binary (e.g., effective or ineffective) or discrete (e.g., rating of 1 to 5).

Delivery: The delivery parameter refers to whether the team, partner, or provider met expectations regarding specific deliverables. Sub-dimensions may include, for example, ‘on time’, ‘on budget’, and ‘extensibility’. The ‘on time’ sub-dimension relates to actual delivery time versus quoted delivery time, and may be measured in binary (e.g., on time or not) or discrete (e.g., 10 if deadline met, and subtract one day for each day late to a minimum of zero) form. The ‘on budget’ sub-dimension relates to actual cost versus quoted cost, and may be measured in binary (e.g., met budget or not) or discrete (e.g., 10 if cost quote met, and subtract one for every 1% in excess of the quote) format. The ‘extensibility’ dimension relates to an elasticity rating of the problem design and current deliverables and the perceived applicability and ease to which they can be extended into derivative future studies. Measurement is subjective, and may be, for example, discrete (e.g., rating of 1 to 5). Z

Velocity: The velocity dimension refers to the iterative frequency of transactions actively being executed within an area of inquiry or problem hierarchy. Sub-dimensions may include, for example, ‘transaction rate’, which refers to the number of transactions performed throughout established phases of an investigation versus how resources are assigned based on the requirements of the investigation at different phases. Measurement may be, for example, a ratio of the number of transactions in a phase versus the number of active team members, or the rate of change of the ratio.

Longevity: The longevity dimension refers to the applicability of an analytic solution over time. Sub-dimensions may include, for example, ‘durability’ and ‘applicability’. The ‘durability’ sub-dimension refers to the relevance of provided results to a future date. The ‘applicability’ sub-dimension refers to the relevance of provided results in the present. Both durability and applicability may be measured in discrete form (e.g., rating of 1 to 5).

Relative platform activity: The relative platform activity dimension refers to the similarity of a users' area of inquiry to others', and the amount of transaction activity on these similar problem areas. Sub-dimensions may include, for example, ‘power user’, where the ‘power user’ sub-dimension refers to the level of transaction activity of the Provider in the analytics platform as compared to other users. Measurement may be binary (e.g., active or inactive) or discrete (e.g., low, medium, high).

In addition to the ten dimensions described above, the analytics platform may provide user-configurable dimensions, where configuration includes naming, how the dimension is rated, and the relative importance of the dimension with respect to one or more other dimensions.

Further, the analytics platform may provide users the ability to define a formula for calculating a custom AEI based on one or more pre-defined or user-defined dimensions. The analytics platform then provides both the platform AEI and the custom AEI to the user.

Trends in the AEI for a Provider may be also be presented in the analytics platform. One example of presentation of a trend is a trend line graph of the AEI plotted by month, quarter, semi-annually, annually, or some other periodicity, or in a non-periodic plot, such as when available at the completion of a project task.

A Provider may seek to increase their AEI, and in some implementations, may do so by using services available on the analytics platform. Services may include software or consulting services that improve the Provider's effectiveness, such as tools or training to improve problem restatement, pro-con analyses, divergent or convergent thinking, application of weighted ranking, testing of hypotheses, use of devil's advocate analyses, sorting of information, and preparing chronologies, time lines, causal flow diagrams, matrices, scenario trees, probability trees, utility trees, or utility matrices, for example.

As will be apparent from the description of the AEI above, the AEI may be ‘living’, in that it can change as any dimension or sub-dimension measurement is entered or modified. Entry or modification of a measurement may occur before, during, or after a task, and also as a Provider's activity on the analytics platform increases or decreases; thus the AEI will generally not be a static number even if a Provider becomes inactive on the analytics platform.

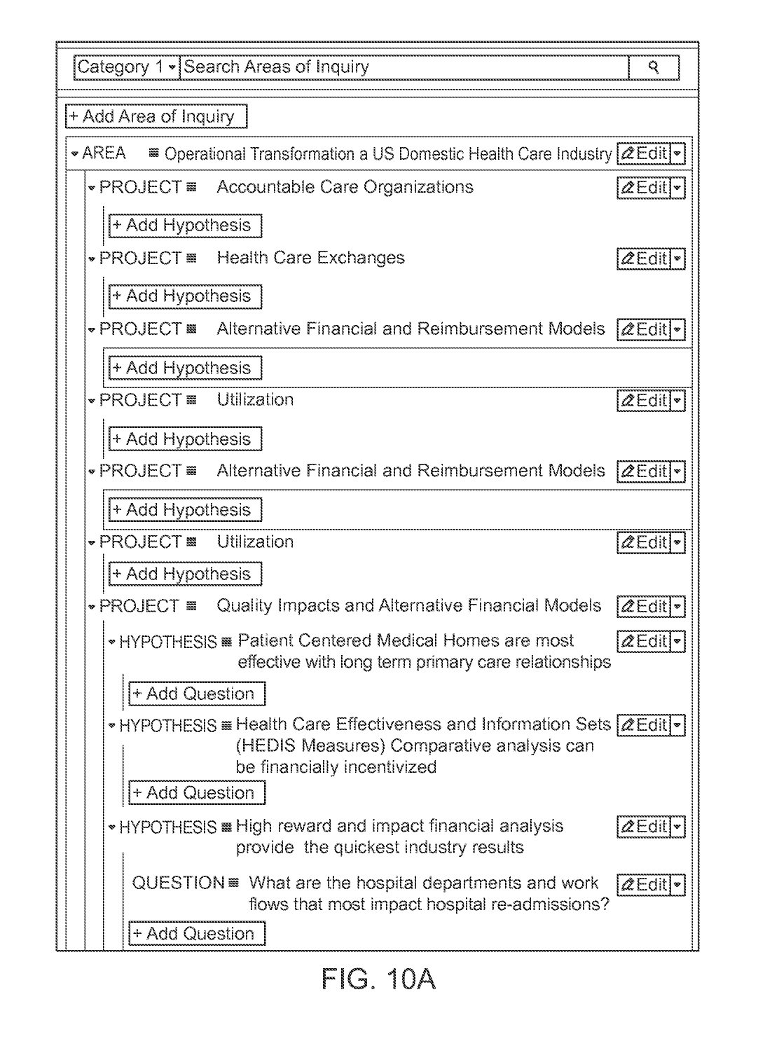

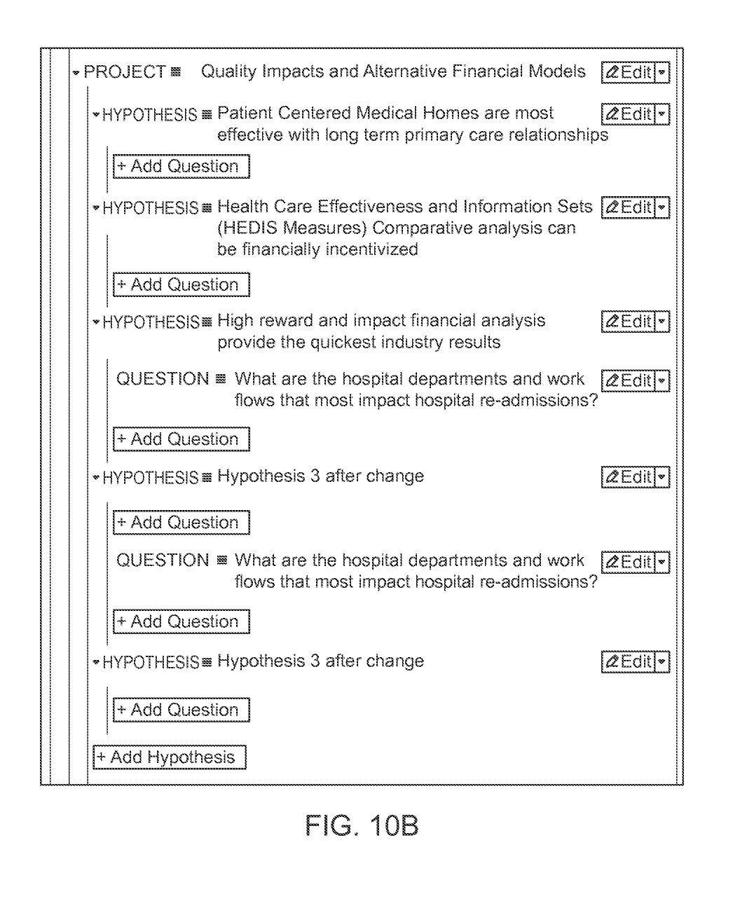

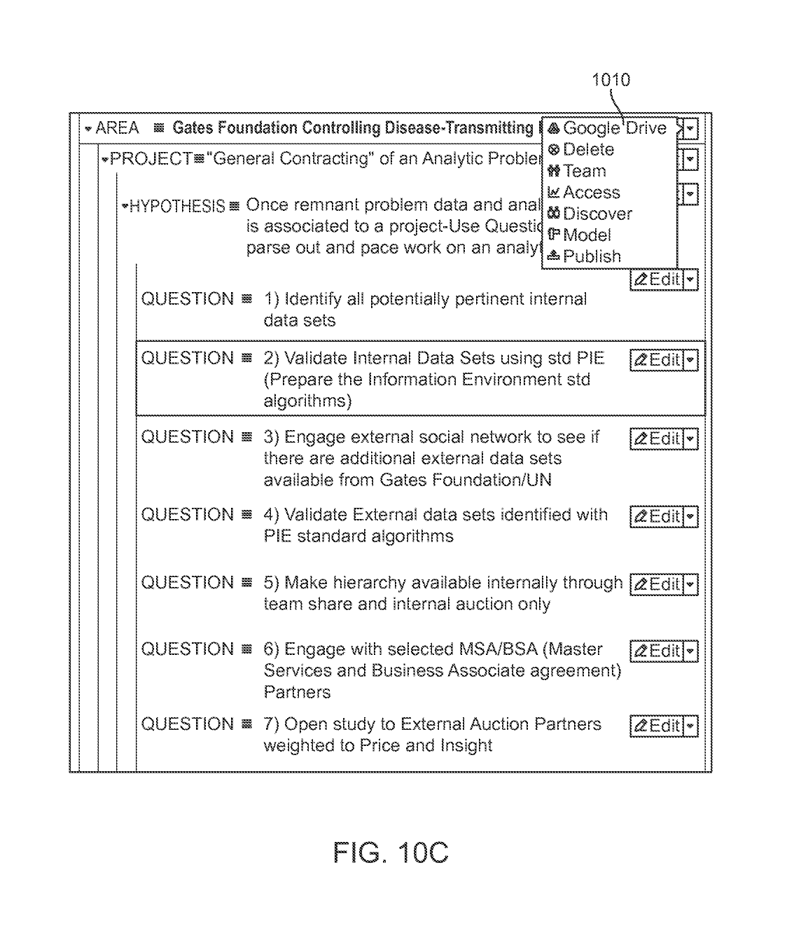

FIG. 10A illustrates one example of how a project management task definer may be presented in one embodiment of an analytics platform. In the example, an Area of Inquiry is shown, with multiple Projects defined. For one project, multiple Hypotheses have been postulated, and one Hypothesis is illustrated with a Question presented.

FIG. 10B illustrates that additional Hypotheses may be added in the task definer, including new Hypotheses postulated after initial results are received.

FIG. 10C illustrates that multiple Questions may be associated with each Hypothesis in the task definer. FIG. 10C also illustrates a control tool menu 1010 associated with the Area of Inquiry. Other control tool menus are associated with Projects, Hypotheses, and Questions, as illustrated.

Thus has been described an analytics platform that provides for definition of a hierarchy, and sourcing and tracking of analytic tasks related to the hierarchy.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. An analytics platform comprising:
a project management tool that makes project management resources available to a requestor user of the plurality of users, the project management resources including a project definer and a task definer;
an effectiveness rating tool configured to provide an analytics effectiveness index for analytics provider users of the plurality of users; and
an auction management tool configured to:
allow the requestor user to specify an analytic task for auction, specify auction parameters and weighting of the auction parameters, and provide the specified analytic task for auctioning to ones of the plurality of users, the specified analytic task having been defined in the task definer and related to a project defined in the project definer;
receive bids on the specified analytic task from at least one of the analytics provider users; and
provide received bids to the requestor user with scoring for each bid based on the parameters and the parameter weighting;
wherein the project management tool, the effectiveness rating tool, and the auction management tool are implemented in at least one non-transitory computer-readable storage medium or computing device.

2. The analytics platform of claim 1, wherein each received bid provided to the requestor user is awarded a total score and is ranked based on the total score and the analytics effectiveness index for the analytics provider user submitting the bid.

3. The analytics platform of claim 1, wherein the analytics effectiveness index is calculated based on at least one of a robustness in an established area of inquiry and insight development.

4. The analytics platform of claim 1, wherein the analytics effectiveness index is calculated based on at least two of the dimensions of construction, data, deliverable clarity, team diversity, transaction leverage, team effectiveness, delivery, velocity, longevity, and relative platform activity.

5. The analytics platform of claim 1, wherein the analytics effectiveness index is calculated based on at least two of the sub-dimensions of: major factors and issues, convergence, divergence, analytic confidence, sanity check, group power, analytic confidence, completeness of data sets overall, completeness of meta data overall, completeness of atomic data sets, and completeness of atomic meta data sets, deliverables provided, deliverables quality, outsiders viewpoint, activity rating, team leader view, team view, on time, on budget, extensibility, transaction rate, durability, applicability, and power user rating.

6. The analytics platform of claim 1, wherein the project management tool allows for an analytic project to be structured and managed throughout a project lifecycle, and wherein the project management tool allows for organization of an area of inquiry and association of one or more hypotheses to the area of inquiry, the project definer allows for definition of one or more projects associated with each hypothesis, and the task manager allows for association of one or more analytic tasks to each project.

7. The analytics platform of claim 6, wherein the project management tool further allows for a grant of access to artifacts associated with an analytic task to ones of the plurality of users.

8. The analytics platform of claim 7, wherein the artifacts include at least one of a problem description, evaluation criteria, an external data set, an internal data set, a statistical model study, a calculation procedure, and a listing of users of the plurality of users who have roles within the area of inquiry.

9. The analytics platform of claim 1, wherein the executable instructions further include instructions to allow for granting and removal of access privileges in an established social network of users within the analytics platform.

10. The analytics platform of claim 1, wherein the executable instructions further include instructions for integration with external social networks.

11. The analytics platform of claim 1, wherein the executable instructions further include instructions for the analytics platform to optimize and route the processing of analytic activities.

12. The analytics platform of claim 11, wherein the executable instructions further include instructions to allow a user to identify an internal infrastructure to the analytics platform, wherein the analytics platform optimizes and routes the processing of analytic activities based in part on the identified internal infrastructure.

13. A non-transitory computer-readable storage medium, comprising executable instructions to:
set up an auction for an analytic problem, including specifying a plurality of award parameters and weights for respective ones of the award parameters;
receive a plurality of bids, each bid including bid information corresponding to the award parameters;
for each bid, establish scores for respective ones of the award parameters based on the bid information;
for each bid, calculate weighted scores for respective ones of the award parameters based on the scores and the weights for the respective ones of the award parameters; and
for each bid, calculate a composite score based on the weighted scores.

14. The non-transitory computer-readable medium of claim 13, wherein the executable instructions to set up the auction further include executable instructions to specify an area of inquiry, data sets to be provided, and deliverable parameters.

15. The non-transitory computer-readable medium of claim 13, wherein the executable instructions to set up the auction further include executable instructions to specify at least one agreement to be executed by a bidder.

16. The non-transitory computer-readable medium of claim 13, wherein the award parameters include a price, a delivery time, and an analysis approach.

17. The non-transitory computer-readable medium of claim 13, further comprising executable instructions to display the bids and the composite scores for respective ones of the bids.

18. The non-transitory computer-readable medium of claim 13, further comprising executable instructions to identify the bid with the highest composite score.

19. The non-transitory computer-readable medium of claim 13, wherein the executable instructions to establish the scores include executable instructions to establish the scores with respect to a common range across all the award parameters.

20. The non-transitory computer-readable medium of claim 13, wherein the executable instructions to establish the scores include executable instructions to scale at least one of the scores with respect to a common range across all the award parameters.
